(19) United States
(12) Patent Application Publication
(10) Pub. No.: US 2025/0001700 A1
(43) Pub. Date: Jan. 2, 2025

(54) ENHANCED SUPPORT GENERATION TECHNIQUES FOR ADDITIVE FABRICATION

(71) Applicant: FORMLABS, INC., Somerville, MA (US)

(72) Inventor: Matthew Nielsen, Somerville, MA (US)

(21) Appl. No.: 18/758,109

(22) Filed: Jun. 28, 2024

Related U.S. Application Data
(60) Provisional application No. 63/523,691, filed on Jun. 28, 2023.

(51) Int. Cl. B29C 64/393; B29C 64/245; B33Y 50/02; B33Y 80/00

(52) U.S. Cl. CPC B29C 64/393; B29C 64/245; B33Y 50/02; B33Y 80/00

(57) ABSTRACT

Methods and systems for generating a support structure for a three-dimensional object in additive fabrication. The method involves utilizing a processor to generate the support structure, which includes a plurality of support pillars with notches, a plurality of contact structures that connect the support pillars to the object, and a plurality of trusses. The trusses are connected to different support pillars at opposite ends, forming a cohesive structure.

### CROSS-REFERENCE TO RELATED APPLICATIONS

The present application claims the benefit under 35 U.S.C. § 119 (e) of U.S. Provisional Patent Application No. 63/523,691, filed Jun. 28, 2023, titled “Enhanced Support Generation Techniques for Additive Fabrication,” which is hereby incorporated by reference in its entirety.

### FIELD OF INVENTION

The present invention relates generally to systems and methods for optimizing support structures in the field of additive fabrication.

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as stereolithography, solid objects are created by successively forming thin layers of a curable photopolymer, typically first onto a substrate and then one on top of another. Exposure to actinic radiation cures a thin layer of liquid photopolymer, which causes it to harden and adhere to previously cured layers or the bottom surface of the build platform.

Fused Deposition Modeling (FDM), also called Fused Filament Fabrication (FFF), is another commonly used additive fabrication technique in 3D printing. In FDM, objects are constructed by extruding and depositing successive layers of molten thermoplastic material through a nozzle onto a build surface. The thermoplastic material is heated to its melting point and then extruded in a controlled manner, allowing it to solidify and adhere to the previously formed layers or the build surface. FDM printers typically utilize a filament of solid thermoplastic material, which is fed into the printer and melted before being deposited in a precise manner to form each layer of the object.

### SUMMARY

According to a first aspect of the present disclosure, there is provided a technique relating to a computer-implemented method of generating a support structure for an object represented by a three-dimensional model, the support structure and the object to be fabricated via additive fabrication, the method comprising: generating, using at least one processor, a support structure for the object, the support structure comprising: a plurality of support pillars, wherein one of more of the plurality of support pillars include one or more notches; a plurality of contact structures coupling support pillars of the plurality of support pillars to the object; and a plurality of trusses, wherein trusses of the plurality of trusses couple to different support pillars of the plurality of support pillars at opposing ends of the truss, and providing instructions to an additive fabrication device that, when executed by the additive fabrication device, cause the additive fabrication device to fabricate the object and the support structure.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and examples will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A shows a perspective view of an example additive fabrication system, where the system is arranged in an initial configuration.

FIG. 1B shows a perspective view of an example additive fabrication system, where the system is arranged in a fabricating configuration.

FIG. 1C shows a perspective view of an example additive fabrication system, where the system is arranged in a finished configuration.

FIGS. 2A-2D depict a user interface brush tool for creating support touchpoints on the surface of a model at variable densities.

FIGS. 3A-3D depict a user interface brush tool for varying existing support touchpoints on the surface of a model.

FIGS. 4A-4C depict a user interface brush tool for creating single support touchpoint on the surface of a model.

FIGS. 5A and 5B present a comparison between traditional support structures and a novel support structure designed to be more easily removable while maintaining adequate support during the 3D printing process.

FIGS. 6A and 6B introduce a novel approach to support generation using topology optimization, resulting in a lighter support structure that still provides uncompromised support during the 3D printing process.

The ideas and concepts illustrated in the various figures of the present invention are not limited to their individual embodiments but can be cross-pollinated to achieve further advancements in additive fabrication.

### DETAILED DESCRIPTION

As described above, in stereolithography a plurality of layers of material are formed by directing actinic radiation onto regions of a liquid photopolymer, which causes the photopolymer to cure and harden in those regions. In stereolithography, as well as a number of other additive fabrication techniques, layers are often formed that overhang or otherwise do not connect to previously formed material. Such layers may lack sufficient structural support to remain planar, in part because the layers may be tens or hundreds of microns in thickness, but also because forces may be applied to these layers during fabrication that could cause them to deform.

As a result, many additive fabrication techniques employ some form of support structure, which is an additional structure or “scaffold” that may be fabricated to support particular regions of a part during its fabrication. Once the part has completed fabrication, the support structure can be removed.

Support generation in additive fabrication (also referred to herein as “3D printing”) can, however, be a challenge for both novice and experienced users. One common issue is that supports can be difficult to remove and may cause damage to the printed parts during post-processing. Additionally, generating an excessive number of supports can lead to wasted resin and increased printing time, which can be both costly and inefficient. Manually placing supports in a print preparation tool (sometimes known as a slicer software) can be a time-consuming and complex task, often resulting in suboptimal support placement. Furthermore, support structures may be overused in certain areas while being insufficient in others, leading to uneven stress distribution and potential failure of the printed object.

Preferably, support structures supply enough mechanical strength during fabrication so that parts are fabricated correctly and do not deform or are otherwise negatively impacted during fabrication. Conversely, however, support structures are preferably also easy to remove with minimal application of force or other effort subsequent to fabrication. These apparently conflicting goals may present a challenge when determining how best to fabricate a support structure for a given part.

The disclosed methods in this invention aim to address these issues by providing enhanced support generation techniques that optimize support placement, minimize material waste, and improve the overall quality and stability of printed objects in 3D printing.

In particular, in some embodiments a support structure may be improved by forming the support structure with one or more weaker regions that are selectively placed to make removing the support structure from the fabricated part easier (e.g., because the support structure can more easily break at one or more weaker regions), while also not significantly increasing the risk of a print failure during fabrication of that part. For example, a weaker region might be selectively formed in a location in a support structure such that: 1) reducing the mechanical strength of the support structure at that location may still result in a support structure that adequately supports the part during its fabrication; and 2) having a weaker support structure at that location may make it easier to separate the support structure from the part after fabrication.

In some cases, one or more such weaker regions may be formed as a ‘notch’, which as used herein, refers to small region in a support structure that is mechanically weaker than the adjacent regions of the support structure. For instance, as described further below, a support pillar formed as a cylinder may comprise a short section within it that is thinner than portions of the cylinder adjacent to the short section. This short section, or notch, may be formed by removing some portion of the cylinder to produce a small part of the cylinder that is mechanically weaker than non-notch portions of the cylinder, such that if force were applied to the cylinder, the cylinder would preferentially break at the notch. In some cases, such a cylinder may include multiple such notches to provide multiple places at which the cylinder would preferentially break.

In some embodiments, tools for defining contact points for a support structure with a part prior to fabrication are provided. The tools may be implemented through a suitable graphical user interface (GUI) that allows a user to easily convey the amount of supports that are desired over a given region of the surface of the part. Conventionally, users allow a computer system to fully determine where a support attaches to a part and/or remove and add touchpoints manually. According to some embodiments, a GUI may provide tools for a user to define a desired density of touchpoints over a given surface area on the part. In some cases, such tools may adjust the number and location of touchpoints in that area while retaining some of the existing touchpoints in that area, so that the user does not lose all the prior work defining touchpoints in the area.

While the primary focus of this disclosure is on improving support generation techniques for stereolithography 3D printing, it is important to note that the proposed methods and systems can also be applied to other 3D printing technologies that utilize support structures. For instance, Fused Deposition Modeling (FDM) is another widely used 3D printing technology that often requires support structures for successful printing of complex geometries. The principles and techniques disclosed herein can be adapted and implemented in FDM and other similar 3D printing technologies to optimize support placement, reduce material waste, and enhance the overall quality and stability of printed objects across various additive manufacturing processes.

Following below are more detailed descriptions of various concepts related to, and implementations of, techniques for designing and fabricating support structures. It should be appreciated that various aspects described herein may be implemented in any of numerous ways. Examples of specific implementations are provided herein for illustrative purposes only. In addition, the various aspects described in the implementations below may be used alone or in any combination, and are not limited to the combinations explicitly described herein.

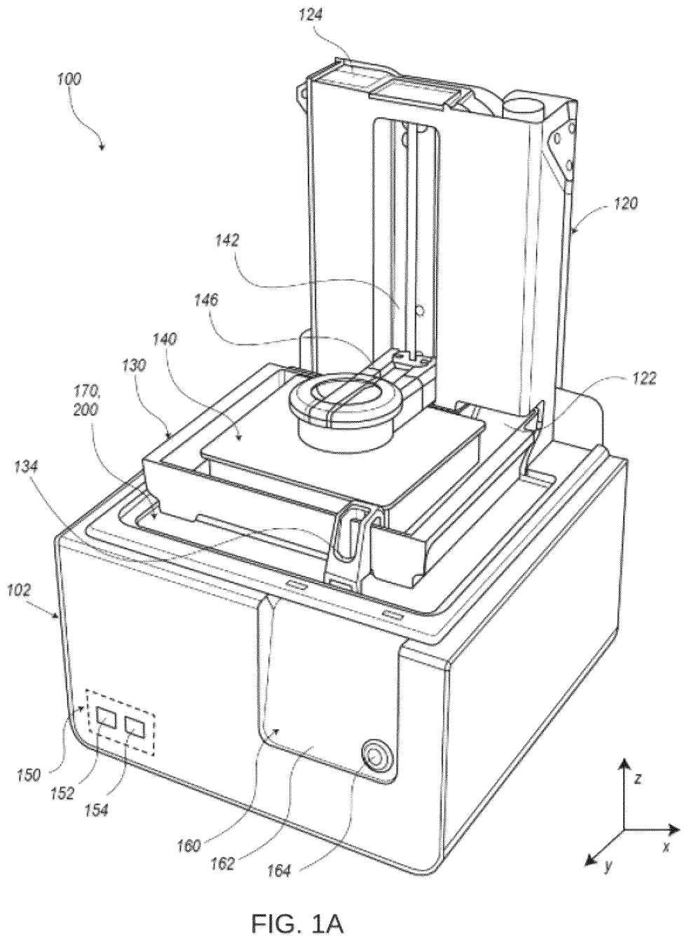

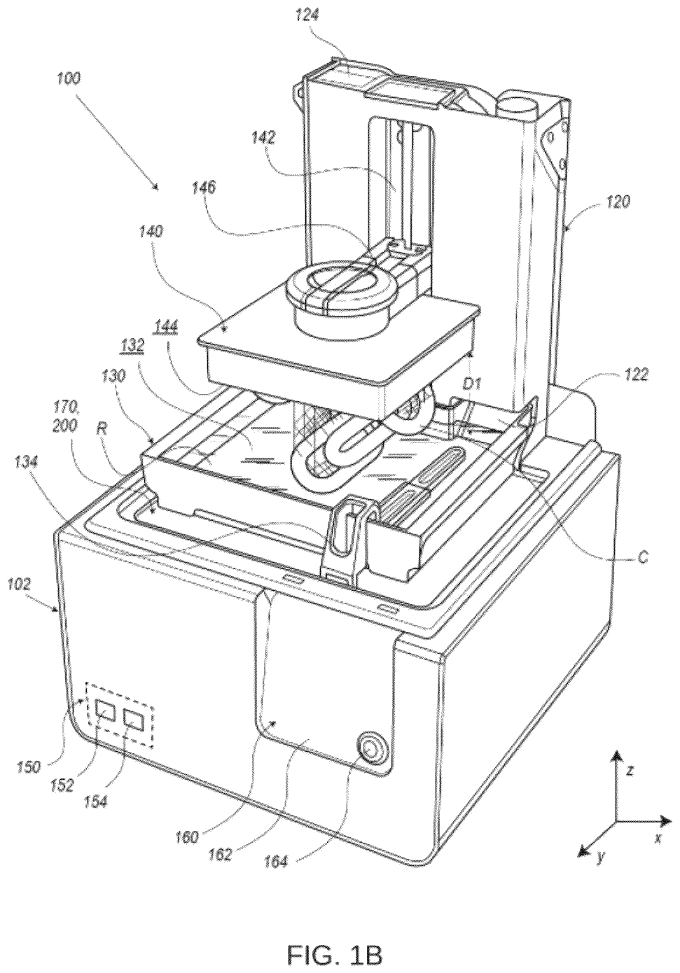

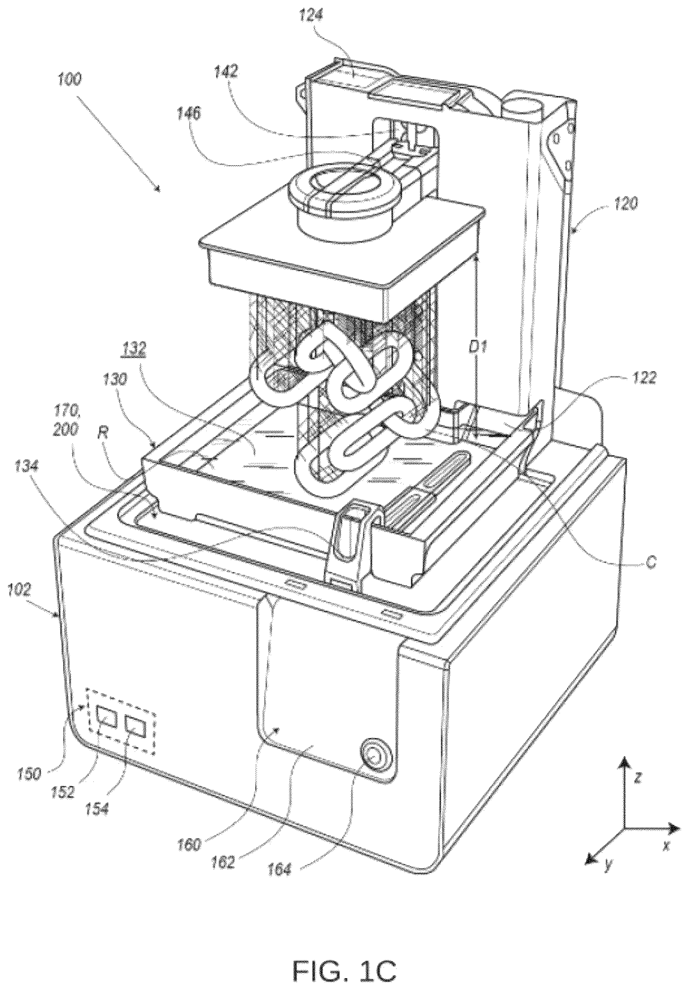

Referring to FIGS. 1A-1C, an additive fabrication device 100, such as a stereolithographic printer, includes a base 110 and a dispensing system 120 coupled to the base 110. The base 110 supports a fluid basin 130 configured to receive a photopolymer resin from the dispensing system 120. The printer 100 further includes a build platform 140 positioned above the fluid basin 130 and operable to traverse a vertical axis (e.g., z-axis) between an initial position (FIG. 1A) adjacent to a bottom surface 132 of the fluid basin 130 and a finished position (FIG. 1C) spaced apart from the bottom surface 132 of the fluid basin 130.

The base 110 of the printer 100 may house various mechanical, optical, electrical, and electronic components operable to fabricate objects using the device. In the illustrated example, the base 110 includes a computing system 150 including data processing hardware 152 and memory hardware 154. The data processing hardware 152 is configured to execute instructions stored in the memory hardware 154 to perform computing tasks related to activities (e.g., movement and/or printing based activities) for the printer 100. Generally speaking, the computing system 150 refers to one or more locations of data processing hardware 152 and/or memory hardware 154. For example, the computing system 150 may be located locally on the printer 100 or as part of a remote system (e.g., a remote computer/server or a cloud-based environment).

The base 110 may further include a control panel 160 connected to the computing system 150. The control panel 160 includes a display 162 configured to display operational information associated with the printer 100 and may further include an input device 164, such as a keypad or selection button, for receiving commands from a user. In some examples, the display is a touch-sensitive display providing a graphical user interface configured to receive the user commands from the user in addition to, or in lieu of, the input device 164.

The base 110 houses a curing system 170 configured to transmit actinic radiation into the fluid basin 130 to incrementally cure layers of the photopolymer resin contained within the fluid basin 130. The curing system 170 may include a projector or other radiation source configure to emit light at a wavelength suitable to cure the photopolymer resin within the basin. Thus, different light sources may be selected depending on the desired photopolymer resin to be used for fabricating a component C. In the present disclosure, the curing system 170 includes a liquid crystal panel for curing the photopolymer resin within the fluid basin 130.

As shown, the fluid basin 130 is disposed atop the base 110 adjacent to the curing system 170 and is configured to receive a supply of the resin R from the dispensing system 120. The dispensing system 120 may include an internal reservoir 124 providing an enclosed space for storing the resin until the resin is needed in the fluid basin 130. The dispensing system 120 further includes a dispensing nozzle 122 in communication with the fluid basin 130 to selectively supply the resin R from the internal reservoir 124 to the fluid basin 130.

The build platform 140 may be movable along a vertical track or rail 142 (oriented along the z-axis direction, as shown in FIGS. 1A-IC) such that base-facing build surface 144 of the build platform 140 is positionable at a target distance D1 along the z-axis from the bottom surface 132 of the fluid basin 130. The target distance D1 may be selected based on a desired thickness of a layer of solid material to be produced on the build surface 144 of the build platform 140 or onto a previously formed layer of the object being fabricated. In some implementations, the build platform 140 is removable from the printer 100. For instance, the build platform 140 may be attached to the rail 142 by an arm 146 (e.g., pressure fit or fastened onto) and may be selectively removed from the printer 100 so that a fabricated component C attached to the build surface 144 can be removed via the techniques described above.

In the example of FIGS. 1A-IC, the bottom surface 132 of basin 130 may be transparent to actinic radiation that is generated by the curing system 170 located within the base 110, such that liquid photopolymer resin located between the bottom surface 132 of the basin 130 and the build surface 144 of the build platform 140 or an object being fabricated thereon, may be exposed to the radiation. Upon exposure to such actinic radiation, the liquid photopolymer may undergo a chemical reaction, sometimes referred to as “curing,” that substantially solidifies and attaches the exposed resin to the build surface 144 of the build platform 140 or to a bottom surface of an object being fabricated thereon.

Following the curing of a layer of the fabrication material, the build platform 140 may incrementally advance upward along the rail 142 in order to reposition the build platform 140 for the formation of a new layer and/or to impose separation forces upon any bond with the bottom surface 132 of basin 130. In addition, the basin 130 is mounted onto the support base such that the printer 100 may move the basin 130 along a horizontal axis of motion (e.g., x-axis), the motion thereby advantageously introducing additional separation forces in at least some cases. A wiper 134 is additionally provided, capable of motion along the horizontal axis of motion and which may be removably or otherwise mounted onto the base 110 or the fluid basin 130.

With continued reference to FIGS. 1A-1C, the printer 100 is shown at different stages of the fabrication process. For example, at FIG. 1A, the printer is shown in an initial state prior to dispensing the resin R into the basin 130 from the reservoir 124 of the dispensing system 120. Upon receipt of fabrication instructions, the printer 100 positions the build surface 144 of the build platform 140 at an initial distance D1 from the bottom surface 132 of the basin 130 corresponding to a thickness of the first layer of resin R to be cured. The curing system 170 then emits an actinic radiation profile (i.e., an image) corresponding to the profile of the current layer of the component C to cure the current layer. Upon curing of the current layer, the build platform 140 incrementally advances upward to the next build position. The distance of each advancement increment corresponds to a thickness of the next layer to be fabricated. The curing system 170 then projects the profile of the component layer corresponding to the new position. The new component layer is cured on a bottom surface of the previous component layer. The curing and advancing steps repeat until the build platform 140 reaches the final position (FIG. 1C) corresponding to the finished component C.

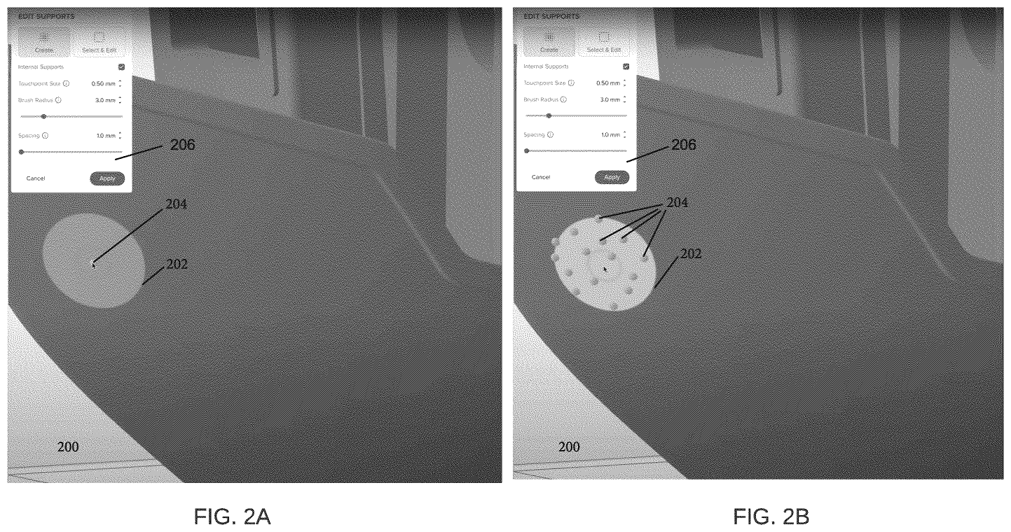

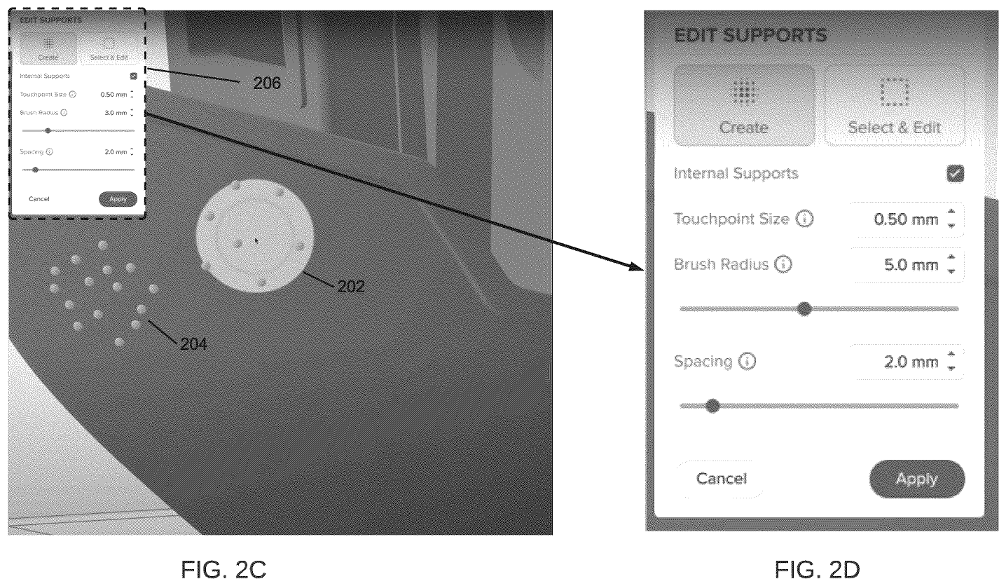

FIGS. 2A-2D depict a user interface brush tool 202 for creating and/or removing support touchpoints 204 on the surface of a model 200 at variable densities, according to some embodiments.

In the example of FIGS. 2A-2D, the brush tool 202 is a graphical user interface-based tool that is utilized by a user when preparing to fabricate one or more 3D models with an additive fabrication device. For instance, a computer-based print preparation tool (such as PreForm of Formlabs) allows for user input to arrange and orient parts, generate support structures, and generate instructions to be sent to an additive fabrication device such that, when the additive fabrication device executes those instructions, the parts and associated support structures are fabricated by the device as dictated by the user input.

The tool depicted in the example of FIGS. 2A-2D is configured to streamline and simplify the process of generating supports for 3D printed parts. The brush tool 202 allows users to efficiently place multiple touchpoints 204 on the surface of the model 200 by using an area-based brush (e.g., occupying a circle), rather than manually placing each support tip individually or relying on an automatic function that may not provide an optimal support structure.

In use, the user can adjust the view so that model 200 is shown from a desired angle, and then position the brush tool 202 over a desired area of the model 200 that requires support, as shown in FIG. 2A. In FIG. 2A, a model 200 is loaded into the print preparation application, and brush tool 202, represented by a grey circle, is positioned on the surface of the model 200. A UI control window 206 is open, allowing the user to adjust the parameters of the brush tool 202, which will be further explained in relation to FIG. 2D. Note that in this brush tool 202, only a single touchpoint 204 is shown, indicating that the user has chosen a low support tip density.

The user may then perform an additional UI operation (e.g., a single mouse click, holding down a mouse key, hitting a keyboard key, etc.) to cause the single support tip be placed at the indicated location on the surface of the model 200.

In FIG. 2B, the user has now increased the density of the touchpoints 204 by moving the depicted slider in the UI control window 206. As a result, multiple touchpoints 204 are shown in the brush tool 202. As previously mentioned, the size of the brush tool 202 and the density of touchpoints 204 within the brush tool 202 can be manually adjusted according to the user's preferences and the specific requirements of the part being printed. For example, the user may adjust brush radius, support tip spacing, support tip size, and other support-related parameters on UI control window 206.

In some embodiments, the brush tool 202 will automatically conform to the surface of the model 200 (e.g., a curved surface), ensuring accurate placement of supports.

Therefore, the brush-based support tip placement tool allows users to place multiple support tips with a single user operation. The process of generating supports becomes significantly faster and more efficient compared to conventional methods. Further, users can easily adjust the size and shape of the brush tool 202 and the density of touchpoints 204 to suit the specific needs of their 3D printed parts, ensuring optimal support during the printing process. For example, an object with a large overhang area may require a large number of supports, while as few supports as possible may be preferable for a small object for which a smooth finish is desired (e.g., a dental crown). The intuitive design of the brush tool makes it simple for users to quickly generate supports for these different objects, or different regions of a single object, even for those with limited experience in 3D printing. By providing a more efficient and customizable method for generating supports, this UI-based tool can help users achieve better print results with fewer errors and less post-processing work.

In some embodiments, the brush tool 202 is configured to create touchpoints on the visible surface of the model 200 at a given spacing (e.g., density). When the brush tool 202 is used over a surface with pre-existing touchpoints 204, these touchpoints 204 will be re-sampled to match the target density.

FIG. 2C shows that the user has moved the brush tool 202 to another area on the model 200, allowing new touchpoints 204 to be placed. The number of touchpoints 204 in this new area is smaller than the number of touchpoints 204 in the area shown in FIG. 2B, as a result of the user adjusting the control settings as shown in UI control window 206.

FIG. 2D shows the parameters of illustrative UI control window 206 in more detail. In general, the UI control window associated with a tool for defining touchpoints as described above may allow a user to define values of any one or more of the following parameters:
Touchpoint size: This parameter determines the size of the support tip that connects to the part at the touchpoint when the support structure is generated based on the defined touchpoints for the part. A larger touchpoint size will result in a more robust connection, while a smaller touchpoint size will be less noticeable but may provide less mechanical support during fabrication.
Brush radius size: This parameter controls the size of the brush area (the grey area in FIGS. 2A-2C). A larger brush radius will cover a larger area of the part, allowing users to generate more support tips with a single click.
Spacing: This parameter determines the density of support tips within the brush radius. A smaller spacing value will result in more closely packed support tips, providing more support to the part during printing. A larger spacing value will create fewer support tips, which may be suitable for areas that require less support.

By adjusting one or more of these parameters in the UI control window, users can easily customize the brush tool to generate the optimal number and distribution of support tips for their 3D printed parts, ensuring a successful print with minimal post-processing work.

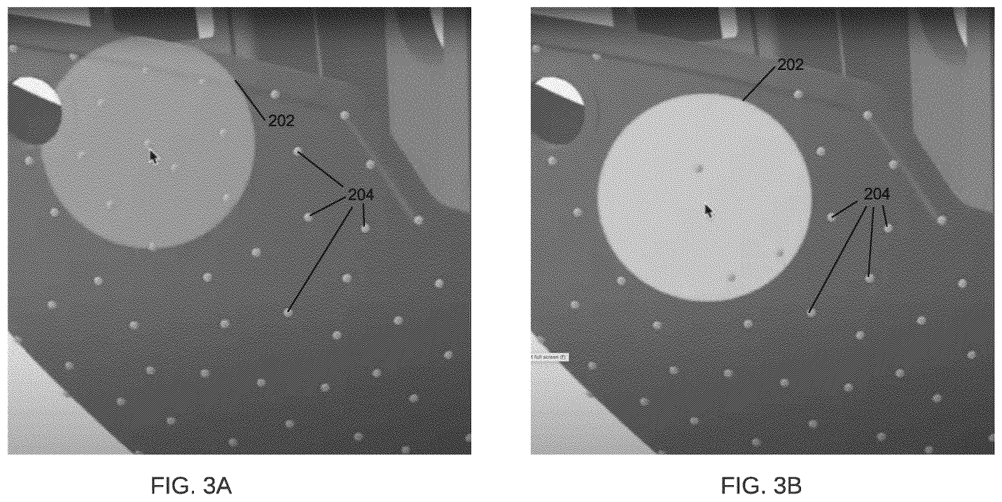

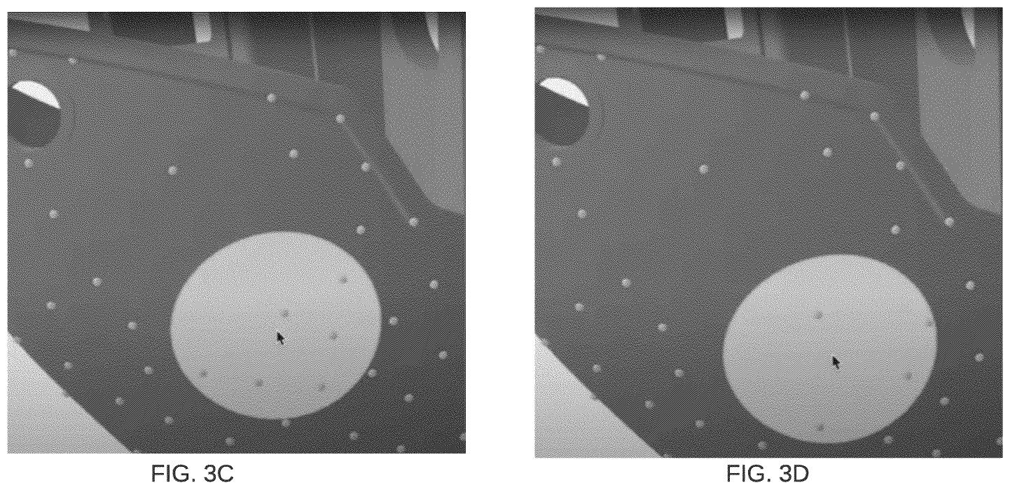

In addition to defining touchpoints on a surface without any defined touchpoints, the same tool may also allow for modification of existing touchpoints, as described below. FIGS. 3A-3D depict the user interface brush tool 202 for varying existing touchpoints 204 on the surface of a model 200, according to some embodiments.

In the example of FIGS. 3A-3D, when the brush tool 202 is applied multiple times to the same surface area, or to overlapping surface areas, the tool may analyze the existing touchpoints 204 in the area and either merge nearby support tips or remove redundant ones to produce the user-defined density and distribution of touchpoints in the area.

According to some embodiments, when a user applies the brush tool 202 to an area containing one or more defined touchpoints, a merging algorithm may be performed by the tool to prevent over-accumulation of touchpoints 204 and maintain a consistent density. For instance, when the area may include more touchpoints that would be desired given the spacing and density parameters, a merging algorithm may estimate the density of existing touchpoints within the area of the brush and remove points until the desired spacing is achieved. To maximize the number of retained points, the merging algorithm may iteratively ranks touchpoints based on suitable criteria and remove touchpoints with the least desirable rankings.

To provide an illustrative example of a merging algorithm with more details, a suitable merging algorithm may work as follows. Initially, the subset of defined touchpoints on the model within the brush area are determined. These groups are referred to subsequently as V (the group of all defined touchpoints on the model) and B (the subgroup of V that lie within the brush's area). Then, for each touchpoint in B, determine how many touchpoints in V are within the defined spacing distance from that touchpoint in B. The touchpoints in B may then be ranked according to the number of touchpoints in V that are within the spacing distance. For instance, if a touchpoint in B is ‘too close’ to two other touchpoints (as defined by the spacing distance), it will be ranked higher than another touchpoint in B that is ‘too close’ to only one other touchpoints. The touchpoint with the highest ranking (i.e., that has the highest number of touchpoints in V that are within the defined spacing distance) is then removed and the touchpoints that remain in B are ranked again. This steps may be repeated until there are no points in B that have touchpoints in V that are within the spacing distance. This process allows the spacing distance to be enforced without redefining all the touchpoints in the brush area, as it only removes certain points to produce the desired result. The points that remain in B are all points that were initially defined prior to the application of the brush.

In some cases, the GUI provides visual feedback to users, such as highlighting the overlapping areas or displaying the resulting support tip density, to help them make informed adjustments.

In FIG. 3A, the UI brush tool 202 is shown with a specific density setting, and the surface of the model 200 is filled with touchpoints 204. The user has placed these touchpoints 204 using the brush tool 202, which has been customized according to the desired density and distribution.

In FIG. 3B, the user has moved the brush tool 202 to a different location on the surface of the model 200. The brush tool 202 now has a different (lower) density setting compared to the one used to place the touchpoints 204 in FIG. 3A. As the brush tool 202 moves across the surface and covers the areas with previously placed support tips, these areas receive a new set of support tips with the updated density setting. Note that before the touchpoints 204 are being placed (e.g., the user clicking on the brush tool 202), the UI may depict what the touchpoints 204 would look like, to help the user decide where to move the brush tool 202. If the user is satisfied with the preview of the support tips placement, the user may perform a UI action (e.g., a mouse click) to place the touchpoints 204.

In FIGS. 3C-3D, the brush tool 202 is moved to another location on the model 200's surface, and the covered area receives new touchpoints 204 with a different density setting. This demonstrates the case with which users can adjust the density of support tips in various areas of the object, ensuring optimal support during the printing process.

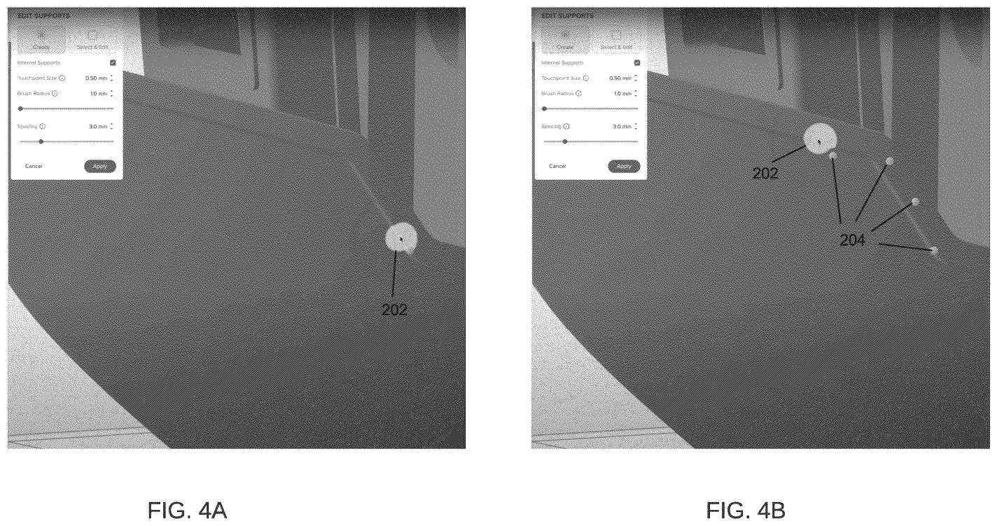

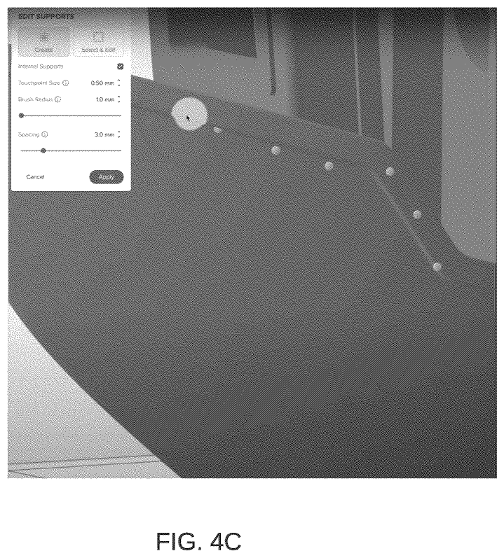

FIGS. 4A-4C depict a user interface brush tool for creating a single support touchpoint on the surface of a model, according to some embodiments.

In FIG. 4A, the brush tool 202 has been activated with its size set to minimum and the density adjusted so that only one support touchpoint occurs within the brush area. This configuration enables the user to place a single support touchpoint as needed, mimicking the traditional method of placing support tips.

FIG. 4B shows that several touchpoints 204 have been placed on the surface of the model 200 using the brush tool 202 with the minimal size and single touchpoint density setting. The user can easily add individual support tip 204 to specific areas of the object, providing precise control over the placement of supports.

FIG. 4C shows the brush tool 202 has been moved to another location on the model 200's surface, and more support tips have been placed using the same minimal size and single touchpoint density setting. This demonstrates the brush tool 200's ability to adapt to different scenarios, allowing users to switch between placing multiple support tips with varying density settings (as shown in FIGS. 3A-3D) and placing single support touchpoints (as shown in FIGS. 4A-4C).

In the computer-based print preparation tool, when placing support tips on curved or uneven surfaces using the brush tool, the tool may employ a combination of surface detection algorithms and adaptive support placement techniques to ensure accurate conformity to the surface geometry while maintaining the desired density and distribution of support tips.

One possible approach is to use a mesh representation of the 3D object surface, which is a common method to represent complex surfaces in 3D modeling and computer-based print preparation tools. By utilizing the mesh data, the computer-based print preparation tool can accurately detect the local surface normals and curvature at the points where the brush tool is applied.

When the user moves the brush tool over the object's surface, the computer-based print preparation tool may continuously updates the brush's position and orientation based on the local surface information. This allows the brush tool to accurately conform to the surface geometry, even on curved or uneven areas.

In addition to surface detection, the computer-based print preparation tool may incorporate adaptive support placement techniques to ensure the desired density and distribution of support tips on complex surfaces. This can be achieved by dynamically adjusting the spacing and positioning of support tips within the brush area based on the local curvature and surface features.

For example, on regions with higher curvature or more complex geometry, the computer-based print preparation tool may reduce the spacing between support tips to provide better support. Conversely, on flatter or less complex regions, the computer-based print preparation tool may increase the spacing between support tips, reducing material usage and support removal complexity.

By combining surface detection algorithms and adaptive support placement techniques, the computer-based print preparation tool ensures that the brush tool accurately conforms to the surface geometry, regardless of its complexity, while maintaining the desired density and distribution of support tips. This results in improved print quality, reduced material usage, and easier support removal for a wide range of 3D printed parts.

In another embodiment, the brush may be a volume-based tool rather than a surface-based tool. A volume-based brush tool in the computer-based print preparation tool could work by allowing users to define support tips within a three-dimensional region or volume rather than just on the surface of the 3D object. This approach can provide more control and flexibility in generating support structures, especially for complex objects with overhangs, internal cavities, or intricate geometries. Below is an example of how a volume-based brush tool could be implemented as part of the computer-based print preparation tool:

1. Defining the brush volume: When activated, the volume-based brush tool may display a three-dimensional region (e.g., a sphere, cube, or custom shape) that can be positioned and resized by the user. This brush volume may serve as a working area for placing support tips.
2. Surface and volume detection: Similar to the surface-based brush tool, the volume-based brush tool would employ surface detection algorithms to identify the object's geometry within the defined brush volume. Additionally, the tool would analyze the internal structure and volume of the object to identify areas that require support, such as overhangs or hollow sections.
3. Adaptive support placement: Based on the detected surface and volume information, the computer-based print preparation tool may dynamically adjust the placement and density of support tips within the brush volume. In areas with more complex geometries or higher stress concentrations, the computer-based print preparation tool could generate denser support structures to provide better support. In less complex or lower stress areas, fewer supports may be generated, reducing material usage and support removal complexity.
4. User interaction: The user can move, resize, and adjust the brush volume, as well as control various parameters such as support tip size, density, and spacing. The computer-based print preparation tool may continuously update the support structures within the brush volume based on the user's input and the object's geometry.
5. Support generation: Once the user is satisfied with the support structures within the brush volume, they can confirm the placement, and the computer-based print preparation tool may generate the final support structures for the entire object, including the supports defined by the volume-based brush tool.

By using a volume-based brush tool, users can have more control over support generation, especially for complex objects with intricate geometries. This approach can result in improved print quality, reduced material usage, and easier support removal for a wide range of 3D printed parts.

In the computer-based print preparation tool, it is possible that the UI of the brush tool includes features or options for users to visualize the stress distribution or load-bearing capabilities of the support structures generated by the brush tool. For instance, a measurement of stress produced by a stress simulation of an object may be indicated in a GUI at multiple points on a model of the object using different shading, color, etc. By providing such visualization, users can better determine if the chosen density and distribution of support tips are sufficient for providing optimal support during the 3D printing process. In some embodiments, the visualization feature can be implemented in the following way:
Stress analysis algorithm: The tool performs a stress analysis algorithm, such as Finite Element Analysis (FEA) or a similar computational method, to estimate the stress distribution and load-bearing capabilities of the support structures generated by the brush tool. This analysis may consider factors such as the material properties, geometry of the 3D object, and the density and distribution of support tips.
Integration with the brush tool: A stress visualization feature may be integrated with the brush tool UI, allowing users to see the estimated stress distribution in real-time as they modify the density and distribution of support tips using the brush tool.
Visual representation: The tool may provide a visual representation of a calculated stress distribution on a support structure, e.g., using color gradients or other visual cues to indicate areas of high stress (red or warm colors) and low stress (blue or cool colors). This visualization helps users to identify areas that may require additional support or modifications to the support structure.
User interaction: In addition to the real-time stress visualization, a stress analysis of the model may be triggered by user input, at any suitable point during the support generation process. This allows the user to evaluate the efficacy of a support structure and make adjustments to the support structure as needed.
Optimization assistance: The tool may provide suggestions or automatic optimization options for adjusting the support structures to better distribute stress and improve load-bearing capabilities. Such suggestions may include recommendations for changing the density of support tips, altering the geometry of the support structures, or adding reinforcements in high-stress areas.

By incorporating stress visualization features and options into the UI of the brush tool, users can gain a better understanding of the load-bearing capabilities and stress distribution of their support structures. This can help them make more informed decisions when generating supports, ultimately resulting in improved print quality and reduced material usage.

In some embodiments, the brush user interface may include the following other features to facilitate the placement and removal of support tips.

Selective removal or modification of support tips: The brush tool UI may include an eraser or modification mode that allows users to selectively remove or modify existing support tips within the brush area. In this mode, users could adjust parameters such as density, size, or distribution pattern for a specific area without affecting the rest of the support structure. This feature may provide users with greater control over the support generation process, enabling them to fine-tune the support structures as needed. Alternatively, users could also use the brush tool with a single support tip placement setting (as described in FIGS. 4A-4C) to manually add or remove support tips in specific areas.

Presets and pre-defined settings for materials and printing techniques: The brush tool UI may offer presets or pre-defined settings tailored to different materials or printing techniques, such as SLA or FDM. These presets may be configured to automatically adjust the brush tool parameters, such as support tip density, size, and spacing, to optimize support generation for the specific material or printing technique being used. Users may select a preset from a drop-down menu or a list of available options, and the computer-based print preparation tool may update the brush tool settings accordingly. This feature simplifies the support generation process for users, ensuring that the support structures are optimized for their chosen material or printing technique, ultimately resulting in better print quality and reduced material usage.

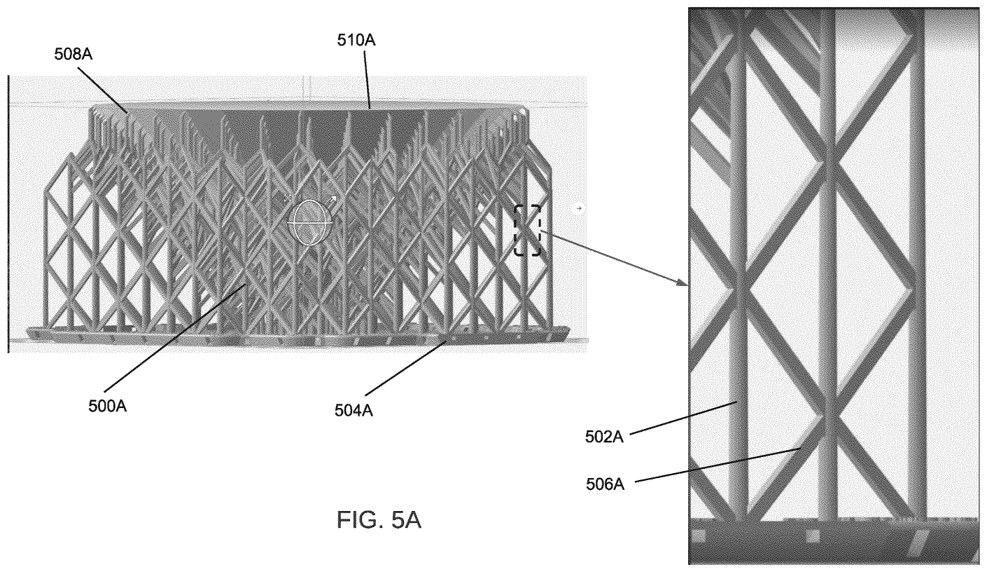

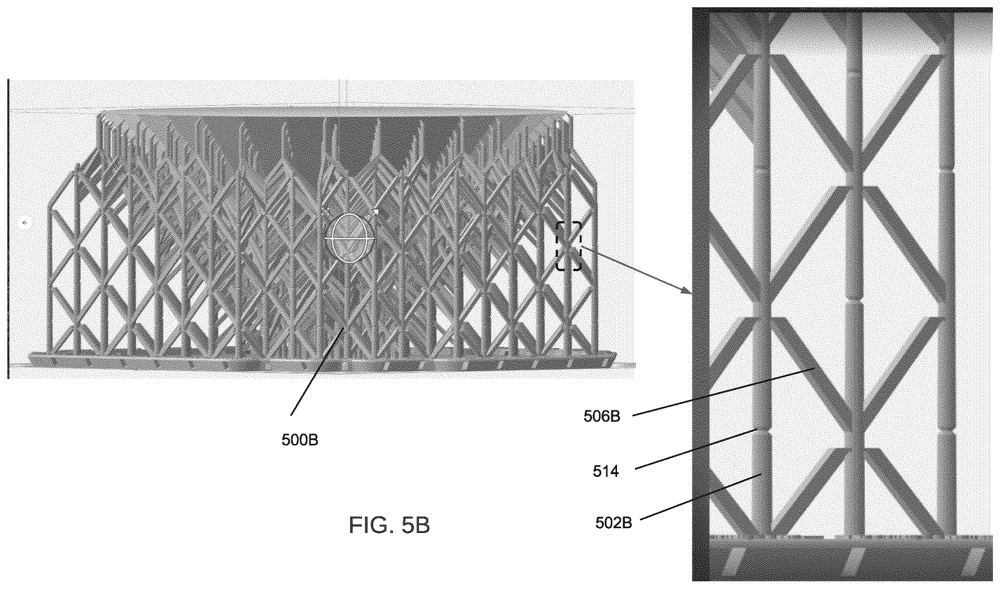

As described above, in some embodiments a support structure may be improved by forming the support structure with one or more weaker regions that are selectively placed to make removing the support structure from the fabricated part easier (e.g., because the support structure can more easily break at one or more weaker regions), while also not significantly increasing the risk of a print failure during fabrication of that part. FIGS. 5A and 5B present a comparison between conventional support structures and an improved support structure that includes weaker regions and as such is configured to be more easily removable while maintaining adequate support during the 3D printing process.

FIG. 5A illustrates a conventional support structure 500A for a 3D printed object 510A. The support structure 500A comprises a raft 504A and support pillars 502A, which are vertical beams that at least in part connect regions of the object 510A to the raft 504A. The raft 504A serves as the base for the support structure 500A in the example of FIG. 5A, although in some other implementations, no raft is included in the support structure and the support pillars are instead connected directly to the build platform. The trusses 506A connect pairs of support pillars 502A to improve the mechanical stability of the support structure. The angled touch tips 508A connect the support pillars 502A to the object 510A.

While this support structure provides adequate support during printing, it has several drawbacks. First, the support pillars 502A can be thick and difficult to break once the part has been fabricated, making support removal challenging. Additionally, using thin support pillars 502A may compromise the support structure during printing. The trusses 506A, while improving stability, also increase material usage and further complicate the support structure removal process.

FIG. 5B shows an improved support structure 500B configured to be more easily removable while still providing sufficient support during the 3D printing process. In the example of FIG. 5B, instead of using support pillars with a uniform cross section, the support structures 500B feature “notches” 514 placed at multiple locations within the support pillars 502B. These notches 514 are thinner sections of the vertical pillar 502B that are designed to break easily under stress, facilitating support removal. Multiple notches 502B can be placed along the length of the support pillar, either evenly spaced or strategically located based on simulated high-stress sections of the support pillar. As an example of the latter, as part of generating a model of the support structure, the computer-based print preparation tool may perform a stress simulation of the support structure and part after fabrication, and determine one or more locations in the support pillars at which stress is concentrated. By placing notches 514 at these locations, the fabricated support structure may be more easily broken.

In addition to the notches, FIG. 5B also depicts trusses 506B that are connected to the support pillars 502B with a thin tip, making their removal easier and less time-consuming. This design reduces the overall material usage and simplifies the support removal process without compromising the stability and support provided during the 3D printing process.

Determining an optimal size, shape, and placement of the notches 514 within the support pillars 502B for the support structure 500B in FIGS. 5A-5B is important for achieving the right balance between easy support removal and sufficient stability during the 3D printing process. In some embodiments, the following approaches may be used to determine the size, shape, and/or placement of the notches:
In some embodiments, the computer-based print preparation tool may perform a method of generating notches, when generating a model of a support structure, based at least in part on the material to be used to form for the support structure. The mechanical properties of the material, such as tensile strength, elongation, and hardness, can influence the size and shape of the notches.
In some embodiments, the computer-based print preparation tool may conduct a finite element analysis (FEA) on a model of a candidate support structure to identify high-stress and low-stress locations within support pillars during the printing process. This can guide the strategic placement of notches within that support structure to optimize their effectiveness without compromising the overall stability of the support structure. For instance, notches may be preferably placed at locations that experience lower stress during fabrication, rather than at high-stress locations, which may cause the part to deform during printing.
The computer-based print preparation tool may analyze various notch sizes and shapes, such as V-shaped, U-shaped, or rectangular notches, to determine the most effective design for easy support removal and minimal impact on stability. The chosen size and shape is preferably be large enough to facilitate easy breaking but not so large that it weakens the support structure during printing.
The computer-based print preparation tool may determine an optimal spacing between notches on the support pillar based on result of a stress analysis and/or on expected material properties of the fabricated support structure. Evenly spaced notches can provide a uniform breaking point, whereas strategically placed notches can target specific high-stress areas, ensuring the support structure remains stable throughout the printing process.
Iterative testing: Perform multiple tests with different notch designs, sizes, and placements. Analyze the results to identify the most effective combination that achieves the desired balance between easy support removal and sufficient stability during printing.

By considering the above factors and more, one can identify the optimal size, shape, and placement of notches within the support pillars of the novel support structure. This approach aims to ensure the support structure provides adequate stability during the 3D printing process while facilitating easy removal once the print is complete.

In some embodiments, a notch arranged within a support pillar may have a width, expressed as a fraction of the width of adjacent portions of the support pillar, of greater than or equal to 40%, 50%, 60%, or 70%. In some embodiments, a notch arranged within a support pillar may have a width, expressed as a fraction of the width of adjacent portions of the support pillar, of less than or equal to 80%, 70%, 60% or 50%. Any suitable combinations of the above-referenced ranges are also possible (e.g., a width, expressed as a fraction of the width of adjacent portions of the support pillar, of greater or equal to 50% and less than or equal to 80%, etc.).

In some embodiments, a notch arranged within a support pillar may be configured to have a fabricated height of greater than or equal to 0.25 mm, 0.5 mm, 0.75 mm, 1 mm, 1.25 mm, 1.5 mm, or 1.75 mm. In some embodiments, a notch arranged within a support pillar may be configured to have a fabricated height of less than or equal to 2.5 mm, 2 mm, 1.75 mm, 1.5 mm, 1 mm, 0.75 mm, or 0.5 mm. Any suitable combinations of the above-referenced ranges are also possible (e.g., a fabricated height of greater or equal to 0.5 mm and less than or equal to 2 mm, etc.).

In some embodiments, to optimize the improved support structure with notches for different 3D printing technologies (e.g., SLA and FDM), the computer-based print preparation tool may base its analysis on the characteristics and limitations of the printing technology. For FDM, the support material is preferably easily separable from the object material, and the notches can be designed to accommodate the layer-by-layer deposition process. In SLA, the support structure can be designed to minimize the peel forces between the printed part and the build platform, and notches can be optimized for the resin's mechanical properties and the laser's exposure settings. By considering the unique requirements and constraints of each 3D printing technology, the novel support structure with notches can be optimized for various applications and materials.

In some embodiments, adapting the novel support structure with notches for complex geometries and overhangs may comprise an analysis of the part geometry and an understanding of the specific support requirements for different areas of the object. For complex geometries, the support structure may be designed to conform to the shape of the object, with notches strategically placed to provide optimal support while maintaining easy removal. Additionally, it may be necessary to adjust the angle, orientation, or branching of the support pillars to accommodate intricate features or cavities. For overhangs, the support structure is preferably designed to provide adequate support at the appropriate angles, ensuring that the notches are placed in a manner that allows for easy removal without compromising the stability of the overhanging sections during printing. By analyzing the geometry of the 3D printed part and customizing the support structure accordingly, the novel support structure with notches can be effectively adapted for complex geometries and overhangs.

Determining the location and number of notches in the support structure is crucial for ensuring optimal support and easy removal without compromising the stability or quality of the printed object. Potential approach for making these determinations include any one or more of the following methods:
Analyze the geometry of the printed object: Examine the shape, size, and complexity of the object to identify areas that may require additional support or are prone to stress during the printing process. This analysis can help guide the placement of notches and support pillars to provide optimal support for the object.
Perform stress analysis: Conduct a finite element analysis (FEA) or other simulation-based analysis to identify high-stress areas in the support structure during the printing process. By understanding the stress distribution, one can strategically place notches in areas where they will facilitate easy removal without compromising the stability of the support structure. For example, one can avoid placing the notches at places where stress is high to increase support rigidity. On the other hand, one can also place the notches at places where the stress is high to increase removability.
Consider material properties: The mechanical properties of the materials used for both the support structure and the printed object can influence the optimal number and location of notches. For example, materials with higher tensile strength or elasticity may require fewer notches, while more brittle materials may require more notches to ensure easy support removal without damaging the printed object.
Evaluate print orientation: The orientation of the printed object on the build platform can affect the location and number of notches required. By optimizing the print orientation, one can minimize the need for support structures and strategically place notches to provide adequate support while facilitating easy removal.
Iterate and test: Perform multiple tests with different notch designs, locations, and quantities to determine the optimal configuration that achieves the desired balance between support stability and easy removal. Analyze the results to identify trends and correlations between the object's geometry, material properties, print orientation, and notch placement.

By considering one or more of the above factors, the optimal location and number of notches in the support structure may be determined that provide the right balance between support stability and easy removal in relation to the printed object.

Performing stress analysis on the support structure and the printed object is a highly desirable step in determining the optimal placement and number of notches. Here is a potential approach to performing stress analysis using finite element analysis (FEA):
Create a 3D model: Develop a 3D model of the printed object along with the support structure, including the proposed notches. It is preferable that this model accurately represents the geometry and material properties of both the object and the support structure.
Discretize the model: Divide the 3D model into smaller elements, such as tetrahedra or hexahedra, to create a mesh. This discretization process allows for the approximation of stress and deformation in the model using finite element equations.
Define boundary conditions and loads: Specify the constraints and loads acting on the model during the printing process. This may include the build platform's fixation, gravitational forces, and any other forces or constraints relevant to the specific 3D printing technology being used.
Select material properties: Assign the appropriate material properties to the 3D model, including elastic modulus, Poisson's ratio, and yield strength. These properties preferably accurately represent the materials used for both the printed object and the support structure.
Solve the finite element equations: Using FEA software, solve the system of finite element equations to determine the stress distribution and deformation throughout the model. This process may involve linear or nonlinear analysis, depending on the complexity of the model and the material properties.
Analyze the results: Examine the stress analysis results, focusing on areas of high stress within the support structure and the printed object. This information can help guide the placement and number of notches to ensure proper support and easy removal without compromising the stability of the support structure during printing.
Iterate and optimize: Based on the stress analysis results, adjust the design of the support structure, the placement and number of notches, and any other relevant parameters. Repeat the stress analysis process to iteratively optimize the support structure design.

By following this approach, stress analysis using finite element analysis to may be performed determine the optimal placement and number of notches within the support structure. This process allows one to better understand the relationship between the support structure, the printed object, and the forces acting on them during the 3D printing process, ensuring that the support structure provides adequate stability while facilitating easy removal.

Improving the design of the truss ends to facilitate easy removal is highly desirable for enhancing the user experience and efficiency of the 3D printing process. Below is an example approach to achieve this goal:
Tapered or thin tip connections: Modify the end of the truss that connects to the support pillar or the object by incorporating a tapered or thin tip. This design change may create a smaller contact area between the truss and the object or pillar, allowing for easier separation and reduced risk of damaging the printed part during removal.
Breakaway features: Integrate breakaway features, such as small perforations or weak points, at the junction between the truss and the support pillar or object. These breakaway features may act as predetermined breaking points, simplifying the removal process and minimizing the force required to separate the truss from the object or pillar.
Flexibility: Consider using a material with higher flexibility or elasticity for the truss ends, allowing them to bend or deform more easily during removal. This flexibility may help reduce the risk of damaging the printed part while removing the support structure.
Customizable connection angles: Design the truss ends to allow for adjustable connection angles to the object or pillar. By optimizing the attachment angle, the truss ends can be more easily removed by applying force in a specific direction, minimizing the risk of damaging the printed part.
Quick-release mechanisms: Incorporate quick-release mechanisms, such as snap-fit connections or interlocking features, into the truss ends. These mechanisms may enable users to easily detach the truss from the object or pillar without the need for excessive force or specialized tools.

By implementing one or more of these design modifications to the truss ends, the support structure removal process can be significantly simplified, reducing the risk of damaging the printed part and improving the overall efficiency of the 3D printing process.

To ensure that the structural integrity of the support structure with notches and thinned end trusses is maintained during the printing process, particularly for large or heavy objects that may exert significant forces on the support structure, the following considerations and strategies can be employed:
Material properties: Select materials with appropriate mechanical properties, such as tensile strength, elongation, and hardness, for both the support structure and the printed object. The material is preferably strong enough to withstand the forces exerted by the object during the printing process without compromising the easy removal of the support structure.
Optimal notch design: Design the notches with dimensions and shapes that maintain the structural integrity of the support pillars while still facilitating easy removal. This can be achieved by experimenting with various notch sizes, shapes (e.g., V-shaped, U-shaped, or rectangular), and placements to find the optimal balance between structural stability and easy removal.
Reinforced trusses: For heavy or large objects, consider reinforcing the trusses with additional material or cross-bracing to provide extra support and stability. This can help distribute the forces exerted by the object more evenly across the support structure, reducing the risk of structural failure during the printing process.
Support density and distribution: Adjust the density and distribution of the support structure to provide adequate support for heavy or large objects. This may involve increasing the number of support pillars or strategically placing supports in areas where the object is most likely to exert significant forces on the structure.
Print orientation and slicing optimization: Optimize the orientation of the printed object on the build platform to minimize the need for support structures and reduce the forces exerted on the support structure during the printing process. Additionally, optimize the slicing settings, such as layer height and print speed, to ensure that the support structure is printed with the necessary strength and accuracy.
Iterative testing and analysis: Perform multiple tests with different notch designs, truss reinforcements, support densities, and print orientations to determine the optimal combination that maintains the structural integrity of the support structure during the printing process. Analyze the results to identify trends and correlations between object size, weight, and support structure stability.

By considering the material properties, optimizing the notch design, reinforcing trusses, adjusting support density and distribution, optimizing print orientation and slicing settings, and iteratively testing and analyzing different configurations, the structural integrity of the support structure with notches and thinned end trusses can be maintained during the printing process, even for large or heavy objects that exert significant forces on the support structure.

Below are more examples of various notch shapes and truss end shapes that can be used in support structures with different pillar geometries such as cylindrical, prism, triangular, or other shapes:
Rectangular notches: These notches have straight edges and are perpendicular to the support pillar's length, creating a simple and uniform weak point along the support pillar for easy breaking.
V-shaped notches: These notches form a V-shape along the support pillar, with the narrowest point at the center, providing a stress concentration point that facilitates easier breaking.
U-shaped notches: These notches have a curved or semi-circular shape, creating a smooth and continuous weak point along the support pillar for easy breaking without sharp edges.
Diamond-shaped notches: These notches have a diamond or rhombus shape, with the narrowest point at the center, providing a stress concentration point while also allowing for more material around the notch for additional support.
Arc-shaped notches: These notches consist of curved sections that form an arc shape, providing a gradual and continuous weak point in the support pillar, which can help in a more controlled breaking process.

Below are some examples of truss shapes:
Tapered ends: These truss ends have a gradually decreasing cross-sectional area towards the point of connection with the support pillar or printed object, providing a smaller contact area that facilitates easier removal.
Spherical or rounded ends: These truss ends have a rounded or spherical shape, which reduces the contact area and allows for more precise control when removing the support structure.
Hook-shaped ends: These truss ends have a hook-like shape, which can provide a secure connection to the support pillar or object while also facilitating easy removal by simply pulling or twisting the hooked end.
Snap-fit ends: These truss ends have interlocking features, such as a male-female connection or a groove and tongue mechanism, that provide a secure connection to the support pillar or object while also allowing for easy detachment with a quick-release motion.
Swivel or hinge-like ends: These truss ends have a swivel or hinge-like connection, which allows for some degree of rotation or movement during the support removal process, making it easier to separate the support structure from the printed object without applying excessive force.

By employing various notch shapes and truss end shapes, the support structure can be optimized for different pillar geometries and printing scenarios, providing a balance between structural stability, material usage, and case of support removal.

In a further embodiment, the notches incorporated into the support pillars may take the form of micro-perforations, offering a nuanced approach to controlled weakening. Instead of a single, continuous cut, the notch is realized as a series of closely spaced, small holes, effectively creating a perforated line of weakness along the support pillar. This design offers several advantages. First, it reduces the overall amount of material used in the notch region compared to a solid cut, potentially leading to cleaner and more predictable breaks during removal. Second, the size and spacing of the holes provide a further degree of control over the breaking point. For instance, smaller, more densely packed holes might be preferred for delicate parts where a lower breaking force is desired, while larger, more widely spaced holes could be suitable for robust prints requiring a higher breaking threshold. The specific size, shape, and arrangement of the holes can be tailored based on factors such as the printing material, the geometry of the supported object, and the desired breaking characteristics. Computational modeling and simulation can be employed to optimize these parameters for specific printing scenarios.

Further enhancing the notch design, the notches may be formed with variable depths along their length, introducing a strategic element to stress concentration and controlled breaking. This means that the notch is not uniform in depth but rather varies strategically along its profile. For example, a notch could be designed to be deepest at its center point, where stress concentration is often highest, and gradually become shallower towards its edges, ensuring the structural integrity of the support pillar is maintained during the printing process. This variable-depth design allows for precise control over the location of the breaking point, effectively concentrating stress at the desired location for more predictable and controlled support removal. The depth profile of the notch can be tailored to match the anticipated stress distribution during printing, ensuring that the support structure provides adequate support while remaining easily removable after printing. This customization can be achieved through computational analysis and simulation, taking into account factors such as the object's geometry, material properties, and printing parameters.

In another embodiment, the support pillars may incorporate interlocking notches to facilitate a unique separation mechanism that minimizes stress on the printed object. These notches are strategically positioned on opposing sides of the support pillar and designed to slightly interlock, providing enhanced stability during the printing process. The interlocking mechanism can take various forms, such as a simple tongue-and-groove design or a more complex geometric interlocking pattern. The key aspect is that the interlocking feature provides a secure connection during printing while allowing for controlled separation post-printing. After the printing process is complete, the interlocking notches can be disengaged with a gentle twisting motion, effectively separating the support pillar from the printed object. This twisting action potentially reduces stress on the printed object compared to directly pulling a pillar away, further minimizing the risk of damage during support removal. The geometry and tolerances of the interlocking notches can be optimized based on the specific printing material and the desired separation force.

A further embodiment introduces the concept of heat-activated weak points within the support structure, offering a clean and controlled separation mechanism. This method involves strategically embedding a material with a significantly different coefficient of thermal expansion compared to the primary printing material. During the design phase, these embedded sections, which could be filaments, rods, or specifically shaped inserts, are strategically placed within the support structure at locations where a clean break is desired. This placement could be, for example, at the base of pillars, within truss connections, or at strategic points along the length of a support element. After the printing process is complete, controlled heat can be applied to the support structure using methods such as hot air, hot water immersion, or localized heating elements. This heat application causes the embedded material to expand or contract at a different rate than the surrounding material, creating localized stress concentrations that weaken the structure at those specific points. This controlled weakening facilitates clean and easy separation of the support structure from the printed object. Careful selection of materials with compatible thermal properties is very important to prevent warping or damage to the printed object during the heat application process. Factors to consider include the glass transition temperature, melting point, and thermal expansion coefficients of both the primary printing material and the embedded material.

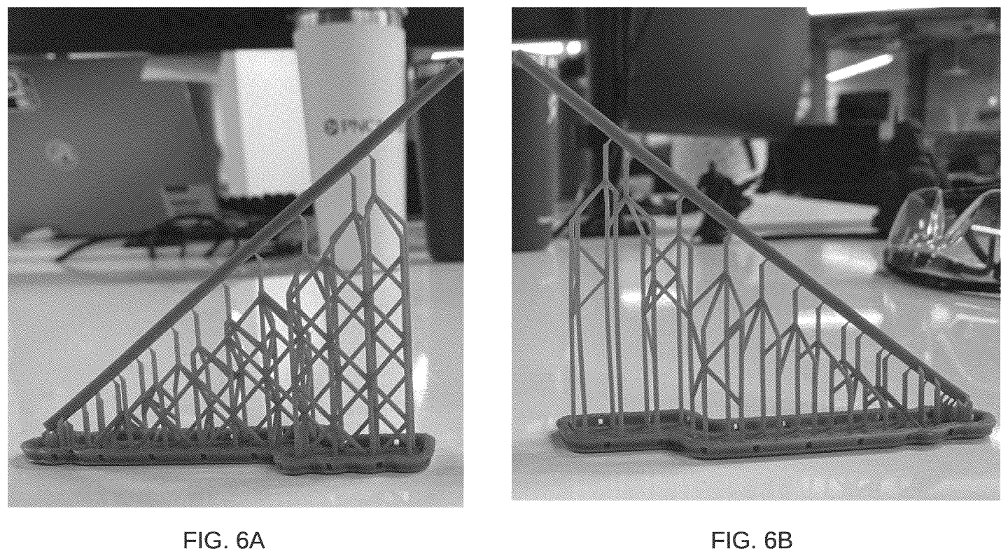

FIGS. 6A and 6B introduce a novel approach to support generation using topology optimization, resulting in a lighter support structure that still provides uncompromised support during the 3D printing process.

In this method, the optimization process begins by generating an initial support structure using traditional methods. The software then analyzes the 3D model's geometry, identifying critical areas that require support, such as overhangs and intricate features, as well as areas where the support structure can be potentially optimized.

The support pillar-level optimization process proceeds as follows:

1. The software selects a pillar to move or modify based on the analysis of the 3D model's geometry and the initial support structure.

2. The selected pillar is moved or modified, and the resulting support structure is evaluated in terms of factors such as stress distribution, stability, overall material usage, and the ability to maintain support for the critical areas identified in the 3D model.

3. If the evaluation shows that the resulting support structure is not optimal or compromises the support for critical areas, the software reverts the changes made to the selected pillar and moves on to another pillar.

4. The process iterates, moving and evaluating different pillars until an optimal support structure is achieved, which ensures adequate support and stability for the critical areas while minimizing material usage.

Throughout the optimization process, the software takes into consideration the complex geometries and overhangs present in the 3D model. It ensures that any changes made to the support structure do not compromise the stability and support required for these critical areas. The software could also employ advanced algorithms, such as machine learning techniques or finite element analysis, to further enhance the optimization process and adapt to varying geometries and printing conditions.

In summary, the support pillar-level topology optimization method effectively handles complex geometries and overhangs in the 3D model by using a combination of iterative evaluation and strategic pillar movement. This approach ensures that the resulting support structure provides adequate support and stability for critical areas while minimizing material usage, ultimately leading to improved 3D printing results.

FIG. 6A illustrates a support structure generated using traditional methods. The support structure consists of a raft, pillars, trusses, and connection structures (also known as support tips) that connect the support to the part. While this traditional support structure provides adequate support during printing, it may be heavier and use more material than necessary.

FIG. 6B presents a topology-optimized support structure, which is significantly lighter than the traditional support structure shown in FIG. 6A, yet still offers uncompromised support during the 3D printing process. This optimized support structure is achieved by applying a pillar-level topology optimization method.

The process of generating this topology-optimized support structure can be described as follows:

1. Generate an initial support structure using traditional methods, as shown in FIG. 6A.

2. Move a support pillar and evaluate the resulting support. This evaluation can be based on factors such as stress distribution, stability, and material usage.

3. If the resulting support is not optimal, return the moved pillar to its original position and select a different pillar to move.

4. Repeat steps 2 and 3 until an optimal support structure is achieved, as shown in FIG. 6B.

This pillar-level topology optimization method differs from other support topology optimization methods that operate on a voxel level. By focusing on the support pillar level, the optimization process becomes much faster and more efficient.
the choice of pillar removal order and the evaluation of the resulting support structure may be based on several factors, such as stability, stress distribution, material usage, and the specific requirements of the 3D model.

The process of choosing the order of pillar removal could involve the following steps:

1. Analyzing the 3D model's geometry: Identify critical areas that require support, such as overhangs and intricate features, and areas where the support structure can potentially be optimized. This analysis can be performed using advanced algorithms and computational tools, such as finite element analysis or machine learning techniques.

2. Prioritizing pillar removal: Based on the analysis, prioritize the removal of pillars that have the least impact on the stability and support of the critical areas in the 3D model. This prioritization can be achieved by assigning a weight or score to each pillar, which represents its importance in providing support to the critical areas.

3. Iteratively removing pillars: Remove the support pillars in the order of their priority, starting with the lowest-weighted or least important pillars. After each removal, evaluate the resulting support structure to ensure that the stability and support for the critical areas are not compromised.

To evaluate the resulting support structure, consider the following factors:

1. Stability: Assess the stability of the support structure, ensuring that it can withstand the forces exerted during the 3D printing process. This can be done using computational tools such as finite element analysis or other simulation methods.

2. Stress distribution: Evaluate the stress distribution within the support structure and the 3D model, ensuring that the stresses are within acceptable limits and do not lead to failure or deformation during printing.

3. Material usage: Compare the material usage of the optimized support structure to the initial support structure, aiming to minimize the material usage without compromising support and stability.

4. Specific requirements of the 3D model: Consider any unique characteristics or requirements of the 3D model, such as specific overhang angles, intricate features, or material properties, and ensure that the optimized support structure adequately addresses these requirements.

By carefully choosing the order of pillar removal and evaluating the resulting support structure based on factors such as stability, stress distribution, material usage, and the specific requirements of the 3D model, the support pillar-level topology optimization method can effectively generate a lightweight and efficient support structure that provides adequate support during the 3D printing process.

In summary, FIGS. 6A and 6B demonstrate the advantages of using topology optimization to generate a lighter support structure that still provides adequate support during the 3D printing process. By optimizing the support structure at the support pillar level, this novel approach offers a faster and more efficient method for support generation, ultimately reducing material usage and improving the overall 3D printing process.

The topology optimization support generation method is designed to adapt to the varying properties of different materials used in 3D printing, such as flexibility, strength, and brittleness. To ensure the optimized support structures are tailored to the specific material being used in the printing process, the software will take into account the material properties during the optimization process.

Users can input specific material properties into the software, or the software can provide predefined profiles for commonly used materials. By incorporating material properties into the optimization process, the software can generate support structures that are best suited for the chosen material, ensuring adequate support during printing while minimizing material usage and simplifying support removal.

For example, when printing with a strong material, the software may generate fewer supports due to the material's inherent strength and ability to support itself during the printing process. On the other hand, when printing with a softer material, the software may generate more supports to compensate for the material's reduced strength and ensure a successful print.

In addition to material properties, the topology optimization support generation method can also adapt to the specific requirements and constraints of various 3D printing technologies, such as Fused Deposition Modeling (FDM) and Stereolithography (SLA). By considering the unique characteristics of each technology, the software can generate optimized support structures that are compatible with different 3D printing processes and materials, ultimately improving print quality and reducing post-processing work.

In conclusion, the topology optimization support generation method offers a versatile and adaptable solution for generating support structures in 3D printing. By taking into account material properties and 3D printing technologies, this innovative method ensures optimized support structures that provide adequate support during printing while minimizing material usage and simplifying support removal. This approach has the potential to significantly enhance the overall 3D printing process, making it more efficient and cost-effective for a wide range of applications.

The topology optimization support generation method is highly versatile and can be effectively applied to various 3D printing technologies that require support structures, including Fused Deposition Modeling (FDM), Stereolithography (SLA), and other emerging techniques. By considering the unique requirements and constraints of each technology, the method generates optimized support structures that are compatible with different 3D printing processes, ensuring adequate support during printing while minimizing material usage and simplifying support removal. This adaptability makes the topology optimization support generation method a valuable tool for enhancing the overall 3D printing process across a wide range of technologies, ultimately improving print quality, reducing post-processing work, and increasing cost-effectiveness for diverse applications in the rapidly evolving field of additive manufacturing.

The ideas and concepts illustrated in the various figures of the present invention are not limited to their individual embodiments but can be cross-pollinated to achieve further advancements in additive fabrication. The combination and integration of different features and techniques from various figures can lead to novel and improved solutions in 3D printing. For instance, the brush tool shown in FIGS. 2A-2D, which allows for precise material deposition and control, can be utilized when creating the novel support structure depicted in FIGS. 5A-5B. By employing the brush tool's capabilities, the support structure can be intricately designed and placed in a manner that optimizes support placement, minimizes material waste, and enhances the overall quality and stability of the printed objects. This integration of the brush tool with the support generation technique exemplifies the potential for cross-pollination among the different embodiments, fostering innovation and advancements in additive fabrication.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including” “comprising” or “having.” “containing” “involving” and variations thereof herein, is meant to encompass the items listed thereafter and equivalents thereof as well as additional items.

What is claimed is:

1. A computer-implemented method of generating a support structure for an object represented by a three-dimensional (3D) model, the support structure and the object to be fabricated via additive fabrication, the method comprising:
generating, using at least one processor, a 3D model representing a support structure for the object, said generating comprising:
generating, using the at least one processor, a plurality of support pillars, wherein a first support pillar of the plurality of support pillars includes one or more notches;
generating, using the at least one processor, a plurality of contact structures that couple support pillars of the plurality of support pillars to the object; and
generating, using the at least one processor, a plurality of trusses, wherein trusses of the plurality of trusses couple to different support pillars of the plurality of support pillars at opposing ends of the truss; and
generating instructions for an additive fabrication device that, when executed by the additive fabrication device, cause the additive fabrication device to fabricate the object and the support structure according to the 3D model representing the object and the 3D model representing the support structure.

2. The computer-implemented method of claim 1, wherein each notch of the one or more notches has a smaller thickness than regions of the first support pillar that are adjacent to the notch.

3. The computer-implemented method of claim 1, wherein the first support pillar is generated to be cylindrical with a first diameter, and wherein the one or more notches are generated to be regions of the first support pillar that are narrower than the first diameter.

4. The computer-implemented method of claim 3, wherein the one or more notches are generated as a cylinder with the first diameter that has a portion of the cylinder removed.

5. The computer-implemented method of claim 4, wherein the portion of the cylinder that is removed is V-shaped, U-shaped, or rectangular.

6. The computer-implemented method of claim 3, wherein the one or more notches are generated to include two truncated or untruncated cones with a circular base having the first diameter.

7. The computer-implemented method of claim 1, further comprising, prior to or while generating the support structure, performing a simulated stress analysis of the support structure in combination with the object, and generate the one or more notches at locations on the first support pillar where the simulated stress analysis indicates a stress value is greater than a predetermined threshold value.

8. The computer-implemented method of claim 1, wherein the plurality of trusses connecting the support pillars have a connecting point with a reduced thickness compared to a middle section of the truss.

9. The computer-implemented method of claim 1, wherein the one or more notches are defined in the 3D model representing the support structure to have a height that is between 0.5 mm and 2 mm.

10. The computer-implemented method of claim 1, wherein the one or more notches are defined in the 3D model representing the support structure to have a width that is between 50% and 80% of a width of the first support pillar.

11. The computer-implemented method of claim 1, wherein the one or more notches are spaced evenly along the length of the first support pillar.

12. The computer-implemented method of claim 1, wherein the notches are placed based on a stress analysis of the support structure.

13. The computer-implemented method of claim 1, wherein the plurality of support pillars are cylindrical, prismatic, or triangular in shape.

14. The computer-implemented method of claim 1, further comprising providing the instructions to the additive fabrication device.

15. An additive fabrication device configured to fabricate an object and a support structure for the object, the additive fabrication device comprising:
at least one processor;
at least one computer-readable medium comprising instructions that, when executed by the at least one processor, generate a 3D model representing a support structure for the object, said generating comprising:
generating, using the at least one processor, a plurality of support pillars, wherein a first support pillar of the plurality of support pillars includes one or more notches;
generating, using the at least one processor, a plurality of contact structures that couple support pillars of the plurality of support pillars to the object; and
generating, using the at least one processor, a plurality of trusses, wherein trusses of the plurality of trusses couple to different support pillars of the plurality of support pillars at opposing ends of the truss; and
a fabrication mechanism configured to access a 3D model representing the object and access the 3D model representing the support structure, and to fabricate the object and the support structure according to the 3D model representing the object and the 3D model representing the support structure.

16. The additive fabrication device of claim 15, wherein the instructions are further configured to, when executed by the at least one processor, perform a simulated stress analysis of the support structure in combination with the object, and generate the one or more notches at locations on the first support pillar where the simulated stress analysis indicates a stress value is greater than a predetermined threshold value.

17. The additive fabrication device of claim 15, wherein the one or more notches are V-shaped, U-shaped, or rectangular.

18. The additive fabrication device of claim 15, wherein the one or more notches are spaced evenly along the length of the support pillars.

19. The additive fabrication device of claim 15, wherein the plurality of support pillars are cylindrical, prismatic, or triangular in shape.

20. At least one non-transitory computer-readable medium storing instructions that, when executed by at least one processor, cause the at least one processor to perform a method of generating a support structure for an object represented by a three-dimensional (3D) model, the support structure and the object to be fabricated via additive fabrication, the method comprising:
generating, using at least one processor, a 3D model representing a support structure for the object, said generating comprising:
generating, using the at least one processor, a plurality of support pillars, wherein a first support pillar of the plurality of support pillars includes one or more notches;
generating, using the at least one processor, a plurality of contact structures that couple support pillars of the plurality of support pillars to the object; and
generating, using the at least one processor, a plurality of trusses, wherein trusses of the plurality of trusses couple to different support pillars of the plurality of support pillars at opposing ends of the truss; and
generating instructions for an additive fabrication device that, when executed by the additive fabrication device, cause the additive fabrication device to fabricate the object and the support structure according to the 3D model representing the object and the 3D model representing the support structure.

21. A computer-implemented method of generating a support structure for an object represented by a three-dimensional (3D) model, the support structure and the object to be fabricated via additive fabrication, the method comprising:
generating, using at least one processor, an initial support structure for the object, the initial support structure comprising a plurality of support pillars, a plurality of contact structures coupling the plurality of support pillars to the object, and a plurality of trusses that couple to different support pillars of the plurality of support pillars at opposing ends of the truss;
performing a topology optimization process on the initial support structure, wherein the topology optimization process comprises using physical simulation to identify portions of the support pillars, contact structures, and trusses that can be removed without adversely impacting printability object during additive fabrication;
removing the identified portions of the support pillars, contact structures, and trusses based on the results of the topology optimization process; and
providing instructions to an additive fabrication device that, when executed by the additive fabrication device, cause the additive fabrication device to fabricate the object and the optimized support structure.
